(19) United States
(12) Patent Application Publication
(10) Pub. No.: US 2025/0301362 A1
(43) Pub. Date: Sep. 25, 2025

(54) INFORMATION PROCESSING METHOD, INFORMATION TRANSMISSION METHOD, AND COMMUNICATION DEVICE

(71) Applicant: VIVO MOBILE COMMUNICATION CO., LTD., Guangdong (CN)

(72) Inventor: Jian YAO, Guangdong (CN)

(21) Appl. No.: 19/231,806

(22) Filed: Jun. 9, 2025

Related U.S. Application Data
(63) Continuation of application No. PCT/CN2023/136277, filed on Dec. 5, 2023.

(30) Foreign Application Priority Data
Dec. 9, 2022 (CN) 202211584314.1

(51) Int. Cl. H04W 24/10

(52) U.S. Cl. CPC H04W 24/10

(57) ABSTRACT

This application discloses an information processing method, an information transmission method, and a communication device, and pertains to the field of communication technologies. The information processing method in embodiments of this application includes: obtaining, by a first device, first indication information, where the first indication information is used to indicate measurement information associated with a first signal, and the first signal is a signal used for measurement; and performing, by the first device, a first operation based on the first indication information. The first operation includes at least one of the following: measuring the first signal to obtain at least one measurement result; and reporting first information, where the first information includes at least one measurement result. The measurement information includes at least one of the following: a sensing measurement type; a measurement quantity; a detection range corresponding to the measurement quantity; and measurement device information.

### CROSS-REFERENCE TO RELATED APPLICATIONS

This application is a continuation application of International Application No. PCT/CN2023/136277, filed on Dec. 5, 2023. International Application No. PCT/CN2023/136277 claims priority to Chinese Patent Application No. 202211584314.1, filed in China on Dec. 9, 2022. Each of the above-listed applications is incorporated herein by reference in its entirety.

### TECHNICAL FIELD

This application pertains to the field of communication technologies, and specifically relates to an information processing method, an information transmission method, and a communication device.

### BACKGROUND

A future mobile communication system has a sensing capability in addition to a communication capability. The sensing capability means that one or more devices that have the sensing capability can sense information such as an orientation, a distance, and a speed of a target object by sending and receiving a wireless signal, or detect, track, identify, and image a target object, an event, an environment, or the like. A sensing receiving device receives a signal used for sensing, measures the signal to obtain a measurement result, and reports the measurement result, for example, reports delay, Doppler, or angle domain information. However, the sensing receiving device may be unable to obtain a measurement result that meets a sensing requirement in a case that a specific feature of a sensing service or a sensing target is not clear.

### SUMMARY

According to a first aspect, an information processing method is provided, including:
obtaining, by a first device, first indication information, where the first indication information is used to indicate measurement information associated with a first signal, and the first signal is a signal used for measurement; and
performing, by the first device, a first operation based on the first indication information.

The first operation includes at least one of the following:
measuring the first signal to obtain at least one measurement result; and
reporting first information, where the first information includes at least one measurement result.

The measurement information includes at least one of the following:
a sensing measurement type;
a measurement quantity;
a detection range corresponding to the measurement quantity; and
measurement device information.

According to a second aspect, an information transmission method is provided, including:
sending, by a second device, first indication information, where the first indication information is used to indicate measurement information associated with a first signal, and the first signal is a signal used for measurement.

The measurement information includes at least one of the following:
a sensing measurement type;
a measurement quantity;
a detection range corresponding to the measurement quantity; and
measurement device information.

According to a third aspect, an information processing apparatus is provided, including:
a first obtaining module, configured to obtain first indication information, where the first indication information is used to indicate measurement information associated with a first signal, and the first signal is a signal used for measurement; and
a first processing module, configured to perform a first operation based on the first indication information.

The first operation includes at least one of the following:
measuring the first signal to obtain at least one measurement result; and
reporting first information, where the first information includes at least one measurement result.

The measurement information includes at least one of the following:
a sensing measurement type;
a measurement quantity;
a detection range corresponding to the measurement quantity; and
measurement device information.

According to a fourth aspect, an information transmission apparatus is provided, including:
a first sending module, configured to send first indication information, where the first indication information is used to indicate measurement information associated with a first signal, and the first signal is a signal used for measurement.

The measurement information includes at least one of the following:
a sensing measurement type;
a measurement quantity;
a detection range corresponding to the measurement quantity; and
measurement device information.

According to a fifth aspect, a terminal (a first device) is provided. The terminal includes a processor and a memory. The memory stores a program or instructions capable of running on the processor, and the program or the instructions are executed by the processor to implement the steps of the method according to the first aspect.

According to a sixth aspect, a terminal (a first device) is provided, including a processor and a communication interface. The communication interface is configured to obtain first indication information, where the first indication information is used to indicate measurement information associated with a first signal, and the first signal is a signal used for measurement. The processor is configured to perform a first operation based on the first indication information.

The first operation includes at least one of the following:
measuring the first signal to obtain at least one measurement result; and
reporting first information, where the first information includes at least one measurement result.

The measurement information includes at least one of the following:
a sensing measurement type;
a measurement quantity;
a detection range corresponding to the measurement quantity; and
measurement device information.

According to a seventh aspect, a network-side device (a first device or a second device) is provided. The network-side device includes a processor and a memory. The memory stores a program or instructions capable of running on the processor, and the program or the instructions are executed by the processor to implement the steps of the method according to the first aspect or the second aspect.

According to an eighth aspect, a network-side device (a first device or a second device) is provided, including a processor and a communication interface. The communication interface is configured to obtain first indication information, where the first indication information is used to indicate measurement information associated with a first signal, and the first signal is a signal used for measurement. The processor is configured to perform a first operation based on the first indication information. The first operation includes at least one of the following: measuring the first signal to obtain at least one measurement result; and reporting first information, where the first information includes at least one measurement result. Alternatively, the communication interface is configured to send first indication information, where the first indication information is used to indicate measurement information associated with a first signal, and the first signal is a signal used for measurement. The measurement information includes at least one of the following:
a sensing measurement type;
a measurement quantity;
a detection range corresponding to the measurement quantity; and
measurement device information.

According to a ninth aspect, an information processing system is provided, including a terminal and a network-side device. The terminal may be configured to perform the steps of the method according to the first aspect, and the network-side device may be configured to perform the steps of the method according to the first aspect or the second aspect.

According to a tenth aspect, a readable storage medium is provided. The readable storage medium stores a program or instructions, and the program or the instructions are executed by a processor to implement the steps of the method according to the first aspect, or to implement the steps of the method according to the second aspect.

According to an eleventh aspect, a chip is provided. The chip includes a processor and a communication interface. The communication interface is coupled to the processor, and the processor is configured to run a program or instructions to implement the method according to the first aspect, or to implement the method according to the second aspect.

According to a twelfth aspect, a computer program/program product is provided. The computer program/program product is stored in a storage medium, and the computer program/program product is executed by at least one processor to implement the steps of the method according to the first aspect or the second aspect.

### BRIEF DESCRIPTION OF DRAWINGS

FIG. 1 is a structural diagram of a communication system applicable to an embodiment of this application is applicable;

FIG. 2 is a schematic flowchart of an information processing method according to an embodiment of this application;

FIG. 3 is a first schematic diagram of a Doppler domain detection result represented by an actual Doppler frequency according to an embodiment of this application;

FIG. 4 is a first schematic diagram of a Doppler domain detection result represented by an FFT index according to an embodiment of this application;

FIG. 5 is a second schematic diagram of a Doppler domain detection result represented by an actual Doppler frequency according to an embodiment of this application;

FIG. 6 is a second schematic diagram of a Doppler domain detection result represented by an FFT index according to an embodiment of this application;

FIG. 7 is a schematic flowchart of an information transmission method according to an embodiment of this application;

FIG. 8 is a schematic module diagram of an information processing apparatus according to an embodiment of this application;

FIG. 9 is a schematic module diagram of an information transmission apparatus according to an embodiment of this application;

FIG. 10 is a structural block diagram of a communication device according to an embodiment of this application;

FIG. 11 is a structural block diagram of a terminal according to an embodiment of this application;

FIG. 12 is a first structural block diagram of a network-side device according to an embodiment of this application; and

FIG. 13 is a second structural block diagram of a network-side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, in the specification and claims, “and/or” represents at least one of connected objects, and the character “/” generally represents an “or” relationship between associated objects.

It should be noted that, a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. The technology described may be used for the systems and radio technologies described above, as well as other systems and radio technologies. A new radio (NR) system is described in the following descriptions for illustrative purposes, and NR terms are used in most of the following descriptions. However, these technologies can also be applied to applications such as a 6th generation (6G) communication system other than NR system applications.

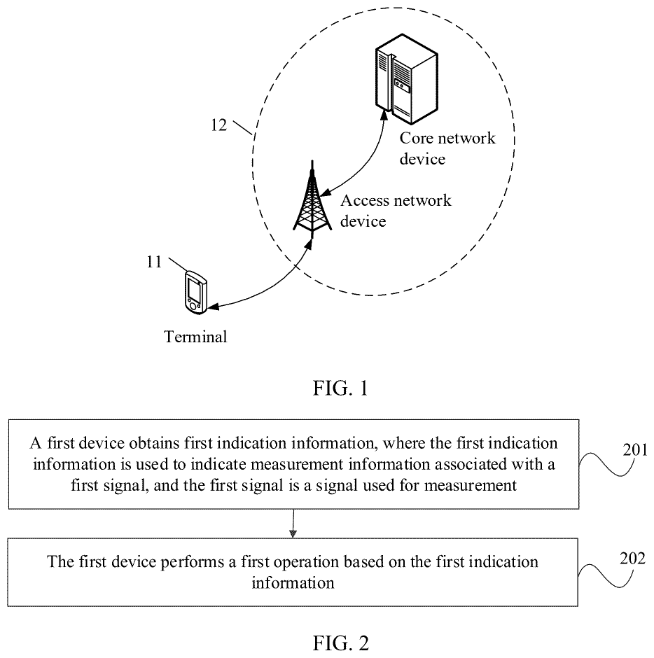

FIG. 1 is a block diagram of a wireless communication system applicable to an embodiment of this application. The wireless communication system includes a terminal 11 and a network-side device 12. The terminal 11 may be a mobile phone, a tablet personal computer (Tablet Personal Computer), a laptop computer or referred to as a notebook computer, a personal digital assistant (PDA), a palmtop computer, a netbook, an ultra-mobile personal computer (UMPC), a mobile internet device (MID), an augmented reality (AR)/virtual reality (virtual reality, VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in the NR system is used as an example for description, and a specific type of the core network device is not limited.

To enable a person skilled in the art to better understand embodiments of this application, the following description is first provided.

A future mobile communication system, such as a B5G system or a 6G system, has a sensing capability in addition to a communication capability. The sensing capability means that one or more devices that have the sensing capability can sense information such as an orientation, a distance, and a speed of a target object by sending and receiving a wireless signal, or detect, track, identify, and image a target object, an event, an environment, or the like. In the future, with the deployment of a small base station with a capability of a high frequency band and large bandwidth such as a millimeter wave and terahertz in a 6G network, resolution of sensing is significantly improved when compared with that of a centimeter wave, so that the 6G network can provide a more refined sensing service. Typical sensing functions and application scenarios are shown in Table 1.

TABLE 1

| Communication | | |
|---|---|---|
| sensing | | |
| category | Sensing function | Application scenario |
| Macro | Weather condition, air | Meteorology, agriculture, |
| sensing | quality, and the like | and life services |
| type | Traffic flow | Intelligent traffic and |
| | (intersections) and | commercial services |
| | crowd flow (subway | |
| | entrances) | |
| | Target tracking, | Many application |
| | distance measurement, | scenarios of a |
| | speed measurement, | conventional radar |
| | outlining, and the like | |
| | Environment | Intelligent driving and |
| | reconstruction | navigation (automobiles/ |
| | | unmanned aerial vehicles), |
| | | smart city (3D maps), |
| | | and network planning |
| | | and network optimization |
| Granular | Action/posture/ | Smart interaction of |
| sensing | expression recognition | smartphones, games, and |
| type | | smart home |
| | Heartbeat/breathing | Health and medical care |
| | and the like | |
| | Imaging, material | Security inspection, |
| | detection, component | industry, biological |
| | analysis, and the like | medicine, and the like |

Integrated communication and sensing means that in a same system, a design of integrated communication and sensing functions is implemented through spectrum sharing and hardware sharing. When transferring information, the system can sense information such as an orientation, a distance, and a speed, and detect, track, and identify a target object or an event. A communication system and a sensing system cooperate with each other, to improve overall performance and bring better service experience.

Integrated communication and radar is a typical application of integrated communication and sensing. In the past, a radar system and the communication system are strictly differentiated due to different research objects and focuses, and the two systems are independently studied in most scenarios. Actually, as typical manners of information sending, obtaining, processing, and exchange, the radar and communication systems share many similarities in terms of a working principle, a system architecture, and a frequency band. The design of integrated communication and radar is highly feasible, mainly embodied in the following aspects: First, both the communication system and the sensing system are based on an electromagnetic wave theory, and obtain and transfer information through transmission and reception of an electromagnetic wave. Second, both the communication system and the sensing system have structures such as an antenna, a transmit end, a receive end, and a signal processor, and hardware resources greatly overlap. With the development of technologies, operating frequency bands of the two systems increasingly overlap. In addition, there are similarities in key technologies such as signal modulation and reception detection and waveform design. Integration of the communication and radar systems can bring many advantages, for example, cost saving, size reduction, power consumption reduction, spectrum efficiency improvement, and mutual interference reduction, thereby improving overall system performance.

Based on different sensing signal sending nodes and receiving nodes, there are six basic sensing manners, which specifically include the following:
(1) Self-sending and self-receiving sensing of a base station: In this sensing manner, a base station A sends a sensing signal, and performs sensing measurement by receiving an echo of the sensing signal.
(2) Inter-base station air interface sensing: In this case, a base station B receives a sensing signal sent by a base station A, and performs sensing measurement.
(3) Uplink air interface sensing: In this case, a base station A receives a sensing signal sent by a terminal A, and performs sensing measurement.
(4) Downlink air interface sensing: In this case, a terminal B receives a sensing signal sent by a base station B, and performs sensing measurement.
(5) Self-sending and self-receiving sensing of a terminal: In this case, a terminal A sends a sensing signal, and performs sensing measurement by receiving an echo of the sensing signal.
(6) Inter-terminal sidelink sensing: In this case, a terminal B receives a sensing signal sent by a terminal A, and performs sensing measurement.

It should be noted that in an actual system, one or more different sensing manners may be selected based on different sensing cases and sensing requirements, and there may be one or more sending nodes and receiving nodes in each sensing manner.

A sensing receiving device receives a signal used for sensing, measures the signal to obtain a measurement result, and reports the measurement result, for example, reports delay, Doppler, or angle domain information. However, the sensing receiving device may be unable to obtain a measurement result that meets a sensing requirement in a case that a specific feature of a sensing service or a sensing target is not clear.

Different sensing services have different requirements for measurement quantity detection and reporting. For example, for static environment reconstruction or obstacle detection, delay and angle information, and the like of a reflection path corresponding to a static target are detected and reported. For respiration monitoring, a Doppler frequency value that meets a respiration frequency range is reported. For highway pedestrian intrusion, information indicating whether a target meeting a specific moving speed range exists, and the like are reported. In addition, for sensing for a specific area, only a delay and an angle value corresponding to a signal path that meets a specific delay and angle range need to be calculated and reported.

For another example, detection results obtained by a receive end using different detection algorithms or measurement methods are different. For example, for delay detection, in a case that a specific sensing service and a specific measurement requirement are unknown, the sensing receiving device reports, by default, a delay value corresponding to a path with a largest amplitude (strongest power) in a delay domain, or a delay value corresponding to a path whose amplitude (power) exceeds a preset threshold (communication measurement usually mainly considers a delay and a Doppler feature of a path with a strong signal, and sensing measurement is for a specific reflection path, and power may be weak), which may be unable to meet a sensing measurement requirement. For example, a moving target (a vehicle, a pedestrian, or the like) in an environment needs to be detected. In a case that static clutter cancellation is not performed, delay domain information or delay-Doppler domain information is obtained based on a channel estimation result (frequency domain channel response information). In this case, power of a reflection path corresponding to the moving target in the environment is lower than that of a reflection path corresponding to another static target, and particularly, may be unable to be detected when a signal-to-noise ratio (SNR) is relatively low. After static clutter cancellation is performed, delay domain information is obtained, or delay-Doppler domain information is obtained. In this case, a reflection path corresponding to a static target in the environment is eliminated, and a delay value corresponding to the moving target can be directly obtained through peak detection or threshold detection (for example, constant false alarm rate (CFAR) detection).

For another example, for sensing measurement by using a sensor, different sensors may be used for different types of target detection. For example, a same device is equipped with a medium-to-long-range millimeter wave radar and a short-range millimeter wave radar. For target detection at different distances or in different areas, different sensors are used for detection and reporting a measurement result.

Therefore, a related solution needs to be designed, so that the sensing receiving device obtains a measurement result that meets a sensing requirement.

The solution in the embodiments of this application may be applied to the following sensing scenarios:
a downlink sensing scenario, where in the scenario, a first device is a terminal, and a second device is a base station or a sensing network function;
an uplink sensing scenario, where in the scenario, a first device is a base station, and a second device is a sensing network function;
an inter-base station sensing scenario, where in the scenario, a first device is a base station A, and a second device is a base station B, a base station, or a sensing network function;
a sidelink (SL) sensing scenario, where in the scenario, a first device is a terminal A, and a second device is a terminal B, a base station, or a sensing network function;
a scenario of self-sending and self-receiving sensing of a base station, where in the scenario, a first device is a base station, and a second device is a sensing network function; and
a scenario of self-sending and self-receiving sensing of a terminal, where in the scenario, a first device is a terminal, and a second device is a base station or a sensing network function.

The sensing network function may also be referred to as a sensing network element or a sensing management function (Sensing MF), and may be located on a RAN side or a core network side. The sensing network function refers to a network node that is in a core network and/or in a RAN and that is responsible for at least one function of sensing request processing, sensing resource scheduling, sensing information exchange, sensing data processing, and the like. The sensing network function may be upgraded based on an AMF or a location management function (LMF) in a 5G network, or may be another network node or a newly defined network node. Specifically, a function feature of the sensing network function/sensing network element may include at least one of the following:

Target information is exchanged with a wireless signal sending device and/or a wireless signal measurement device (including a target terminal, a serving base station of a target terminal, or a base station associated with a target area), where the target information includes a sensing processing request, a sensing capability, sensing-assisted data, a sensing measurement quantity type, sensing resource configuration information, and the like, to obtain a target sensing result or a value of a sensing measurement quantity (an uplink measurement quantity or a downlink measurement quantity) sent by the wireless signal measurement device. The wireless signal may also be referred to as a sensing signal.

A sensing method to be used is determined based on factors such as a type of a sensing service, sensing service consumer information, required sensing quality of service (QoS) requirement information, a sensing capability of the wireless signal sending device, and a sensing capability of the wireless signal measurement device. The sensing method may include: A base station A performs sending and a base station B performs receiving, a base station performs sending and a terminal performs receiving, the base station A independently performs sending and independently performs receiving, the terminal performs sending and the base station performs receiving, the terminal independently performs sending and independently performs receiving, a terminal A performs sending and a terminal B performs receiving, or the like.

A sensing device for serving the sensing service is determined based on factors such as the type of the sensing service, the sensing service consumer information, the required sensing QoS requirement information, the sensing capability of the wireless signal sending device, and the sensing capability of the wireless signal measurement device, where the sensing device includes the wireless signal sending device and/or the wireless signal measurement device.

Overall coordination and scheduling of resources required for the sensing service are managed. For example, sensing resources of the base station and/or the terminal are correspondingly configured.

Data processing is performed on the value of the sensing measurement quantity, or calculation is performed to obtain a sensing result. Further, the sensing result is verified, sensing precision is estimated, and so on.

An information processing method provided in embodiments of this application is described in detail below with reference to the accompanying drawing by using some embodiments and application scenarios thereof.

As shown in FIG. 2, an embodiment of this application provides an information processing method, including:

Step 201: A first device obtains first indication information, where the first indication information is used to indicate measurement information associated with a first signal, and the first signal is a signal used for measurement.

Optionally, the first device obtains the first indication information sent by a second device.

Optionally, the measurement information is determined based on a sensing requirement.

Optionally, the first signal is a signal used for sensing measurement, and the first signal may be sent by the second device and received by the first device, may be sent by another device and received by the first device, or may be independently sent and received by the first device.

Optionally, the first signal includes at least one of the following:
a communication reference signal, for example, a channel state information reference signal (CSI-RS), a physical downlink shared channel (PDSCH), or a demodulation reference signal (DMRS);
a synchronization signal, for example, a primary synchronization signal (PSS) or a secondary synchronization signal (SSS);
a sensing signal, for example, a sensing signal designed based on a Gold sequence or a ZC sequence, or a sensing signal designed based on a chirp/frequency modulated continuous wave (FMCW); and
a communication data signal, where the communication data signal is a signal used to carry communication data information.

Step 202: The first device performs a first operation based on the first indication information.

The first operation includes at least one of the following:
measuring the first signal to obtain at least one measurement result; and
reporting first information, where the first information includes at least one measurement result.

In this embodiment of this application, the first device obtains the first indication information, and measures the first signal based on the first indication information to obtain the measurement result and/or report the measurement result. The first indication information is used to indicate the measurement information associated with the first signal, such as a sensing measurement type, a measurement quantity, a detection range corresponding to the measurement quantity, and/or measurement device information. Therefore, corresponding measurement information may be set based on a sensing requirement, so that the measurement result obtained based on the first indication information can meet the sensing requirement, thereby effectively improving sensing performance.

Optionally, the first indication information includes the sensing measurement type, and the method further includes:
determining, by the first device based on the sensing measurement type, at least one of a processing manner of a measurement result, the detection range corresponding to the measurement quantity, and a measurement device.

For example, if the sensing measurement type is a motion type, it is determined that the processing manner of the measurement result includes static clutter cancellation processing. A to-be-detected Doppler frequency range is selected based on whether a high-speed moving target is to be detected; a to-be-detected delay range is selected based on whether a long-range target is to be detected; or a corresponding sensor (short-range millimeter wave radar/medium-to-long-range millimeter wave radar) is selected based on whether a long-range target is to be detected.

Optionally, the reporting first information includes at least one of the following:
reporting a measurement result of a measurement target corresponding to the sensing measurement type;
reporting a measurement result of a measurement target in the detection range; and
reporting a measurement result measured by a measurement device corresponding to the measurement device information.

For example, if the sensing measurement type is a motion type, a measurement result of a motion measurement target is reported, and the measurement result of the motion measurement target may be specifically a measurement result obtained after static carrier cancellation is performed.

Optionally, the measurement information includes at least one of the following:
a sensing measurement type, where the sensing measurement type may also be described as a to-be-sensed target type;
a measurement quantity, where the measurement quantity includes at least one of the following: a delay/distance, Doppler/a speed, an angle, intensity, an acceleration, whether a measurement target exists, a quantity of measurement targets, a location of the measurement target, and the like;
a detection range corresponding to the measurement quantity, where the detection range may also be described as a filtering parameter, for example, filtering a delay domain/Doppler domain/angle domain result, and reserving a result in the corresponding detection range; and
measurement device information, where the measurement device information includes sensor information.

Optionally, the detection range includes at least one of the following:
a Doppler or speed detection range;
a delay or distance detection range;
an angle detection range; and
a location detection range.

Optionally, the first indication information is further used to indicate a quantity of measurement targets corresponding to target information.

The target information includes at least one of the sensing measurement type, the detection range, and the measurement device information.

In this embodiment of this application, in a case that the second device has specific sensing prior information, the first indication information may be used to indicate a quantity of measurement targets corresponding to each sensing measurement type, a quantity of measurement targets corresponding to each detection range, and/or a quantity of measurement targets corresponding to each measurement device. In other words, the first indication information is used to indicate a quantity of measurement results expected to be reported by the second device.

A quantity of measurement results corresponding to each sensing measurement type is the same as or different from a quantity of measurement targets corresponding to the sensing measurement type.

A quantity of measurement results corresponding to each detection range is the same as or different from a quantity of measurement targets in the detection range.

A quantity of measurement results corresponding to each measurement device is the same as or different from a quantity of measurement targets measured by the measurement device.

Optionally, the first information further includes at least one of the following:
target information corresponding to the measurement result; and
a quantity of measurement targets corresponding to the target information.

Optionally, the sensing measurement type includes at least one of the following:
a motion type;
a static type;
a short-range type; and
a long-range type.

Optionally, the motion type includes at least one of the following:
a high-speed motion type; and
a low-speed motion type.

In an implementation of this application, the first information includes the sensing measurement type, a quantity of measurement targets corresponding to the sensing measurement type, a corresponding quantity of sensing measurement results. For example, the first information is {type 1 (static target), x, (x1, y1, z1), (x2, y2, z2), . . . }; {type 2 (moving object), y, (x1′, y1′, z1′), . . . }, where x and y respectively each represent a quantity of sensing measurement targets.

Optionally, the first indication information is further used to indicate configuration information of the first signal.

Optionally, the method in this embodiment of this application further includes:
receiving the first signal based on the configuration information of the first signal.

Optionally, the configuration information of the first signal includes at least one of the following:
a signal resource identifier, where the signal resource identifier is used to distinguish configuration information of different first signals;
a waveform, where the waveform is, for example, orthogonal frequency division multiplex (OFDM), single-carrier frequency-division multiple access (SC-FDMA), orthogonal time frequency space (OTFS), a frequency modulated continuous wave (FMCW), and a pulse signal;
a subcarrier spacing, for example, a subcarrier spacing of 30 KHz in an OFDM system;
a guard interval, where the guard interval is a time interval between a moment at which sending of a signal ends and a moment at which a latest echo signal of the signal is received; the parameter is proportional to a maximum sensing distance, and may be obtained, for example, through calculation of c/(2R_max), where R_max is the maximum sensing distance (which belongs to sensing requirement information), and for example, for a self-sent and self-received sensing signal, R_max represents a maximum distance from a receiving/transmitting point of the sensing signal to a target; in some cases, an OFDM signal cyclic prefix (CP) may serve as a minimum guard interval; and c is a speed of light;
a frequency domain start location, that is, a start frequency, which may alternatively be a start RE or RB index;
a time domain start location, that is, a start time point, which may alternatively be a start symbol, timeslot, or frame index;
a time domain resource length T, also referred to as burst duration, where the time domain resource length is inversely proportional to Doppler resolution;
a time domain resource interval ΔT, where the time domain resource interval is a time interval between two adjacent signals, and the time domain resource interval is associated with a maximum unambiguous Doppler frequency shift or a maximum unambiguous speed;
a frequency domain resource length B, that is, a frequency domain bandwidth, where the frequency domain bandwidth is inversely proportional to distance resolution, and a frequency domain bandwidth of each first signal is B≥c/(2ΔR), where c is a speed of light, and ΔR is the distance resolution;
a frequency domain resource interval ΔF, where the frequency domain resource interval is inversely proportional to a maximum unambiguous distance/delay, where for an OFDM system, a time-frequency domain interval is equal to a subcarrier spacing when subcarriers are continuously mapped;
signal power, for example, selecting a value every 2 dBm from −20 dBm to 23 dBm;
sequence information, for example, type information of a used generation sequence (a ZC sequence or a PN sequence) and a generation manner;
a signal direction; and angle information or beam information sent by a signal; and
a quasi co-location (QCL) relationship.

Indication of the time domain resource length T, the time domain resource interval ΔT, the frequency domain resource length B, and the frequency domain resource interval ΔF is used as an example. It is assumed that there are two types of configurations for each parameter, a set of configuration with a relatively small value is: T1, ΔT1, B1, and ΔF1, and a set of configuration with a relatively large value is: T2, ΔT2, B2, and ΔF2. An association manner may be shown in Table 2.

TABLE 2

| | Measurement quantity | |
|---|---|---|
| Sensing | and a detection range | |
| measurement | corresponding to the | Signal |
| type | measurement quantity | configuration |
| Type 1 (detection | Doppler detection range: | Configuration 1 |
| of a high-speed | \|fd\| ≥ f1 Hz; and | (T1, ΔT1, B2, |
| and short-range | delay detection | and ΔF2) |
| target) | range: τ ≤ τ1 ns | |
| Type 2 (detection | Doppler detection range: | Configuration 2 |
| of a low-speed | \|fd\| ≤ f2 Hz; and | (T2, ΔT2, B2, |
| and short- | delay detection | and ΔF2) |
| range target) | range: τ ≤ τ1 ns | |
| Type 3 (detection | Doppler detection range: | Configuration 3 |
| of a high-speed | \|fd\| ≥ f1 Hz; and | (T1, ΔT1, B1, |
| and long-range | delay detection | and ΔF1) |
| target) | range: τ ≥ τ2 ns | |
| Type 3 (detection | Doppler detection range: | Configuration 4 |
| of a low-speed | \|fd\| ≤ f2 Hz; and | (T2, ΔT2, B1, |
| and long- | delay detection | and ΔF1) |
| range target) | range: ≥τ2 ns | |
| Type 4 (detection | Doppler detection range: | Configuration 2 |
| of a static and | \|fd\| = 0 Hz; and | (T2, ΔT2, B2, |
| short-range | delay detection | and ΔF2) |
| target) | range: τ ≤ τ1 ns | |
| Type 5 (detection | Doppler detection range: | Configuration 1 |
| of a moving and | \|fd\| > 0 Hz; and | (T1, ΔT1, B2, |
| short-range | delay detection | and ΔF2) |
| target) | range: τ ≤ τ1 ns | |
| . . . | . . . | . . . |

It should be noted that a part or all of the configuration information of the first signal may be determined based on the first indication information, or may be directly sent by the second device to the first device.

The following describes the information processing method in this application with reference to embodiments.

In an embodiment of this application, the information processing method includes the following:
(1) A second device sends first indication information to a first device, where the first indication information is used to indicate a sensing measurement type.

The sensing measurement type includes at least one of the following:
a motion type;
a static type;
a short-range type; and
a long-range type.

For example, 1 bit is used to indicate whether the sensing measurement type is the motion type, where “0” indicates a non-motion type, and “1” indicates the motion type.

The sensing measurement type is associated with at least one of a measurement method (for example, whether to perform static clutter interference cancellation or whether to perform specific delay domain filtering or Doppler domain filtering), a detection range corresponding to a measurement quantity, and configuration information of a first signal.
(2) The first device receives and measures the first signal and feeds back a measurement result based on the first indication information.

Specifically, the first device determines, based on the sensing measurement type, configuration information of the first signal used for sensing measurement, for example, determines, based on the sensing measurement type, configuration information, such as a time domain resource length T, a time domain resource interval ΔT, a frequency domain resource length B, and a frequency domain resource interval ΔF, that is used for the first signal; and receives the first signal based on the signal configuration information and measures the first signal.

The first device determines a corresponding measurement method based on the sensing measurement type, for example, selects, based on whether a moving target is to be detected, whether to perform static clutter cancellation processing on a measurement result; selects a to-be-detected Doppler frequency range based on whether a high-speed moving target is to be detected; selects a to-be-detected delay range based on whether a long-range target is to be detected; or selects a corresponding sensor (a short-range millimeter wave radar/medium-to-long-range millimeter wave radar) based on whether a long-range target is to be detected.

The first device reports, based on the indicated sensing measurement type, a measurement result that meets a requirement, for example, if the indicated sensing measurement type is the motion type, reports a measurement result corresponding to a moving target, for example, a delay value corresponding to a path with strongest power in a delay domain after static clutter cancellation is performed.

In this embodiment of this application, in addition to the measurement result, information related to the measurement result may be reported, for example, the sensing measurement type corresponding to the measurement result and/or a quantity of measurement targets corresponding to the sensing measurement type.

For example, if the indicated sensing measurement type includes the static type and the motion type, and the measurement quantity is coordinates, reported content may be:

{type 1 (static target), x, (x1, y1, z1), (x2, y2, z2), ...}; or
{type 2 (moving object), y, (x1′, y1′, z1′), ...},

where x and y each represent a quantity of measurement targets.

The measurement result corresponds to the measurement quantity, that is, is a value of the measurement quantity. The measurement quantity includes at least one of the following: a delay/distance, Doppler/a speed, an angle, intensity, an acceleration, whether a measurement target exists, a quantity of measurement targets, a location of the measurement target, and the like.

In an embodiment of this application, the information processing method includes the following:
(1) A second device sends first indication information to a first device, where the first indication information is used to indicate a detection range corresponding to a measurement quantity.

The detection range corresponding to the measurement quantity may also be described as a filtering parameter. For example, a delay domain/Doppler domain/angle domain result is filtered based on the detection range indicated by the first indication information, and a result in the corresponding detection range is reserved.

Optionally, the detection range includes at least one of the following:
a Doppler or speed detection range;
a delay or distance detection range;
an angle detection range (Field of View, FoV), which may be an angle range in a global coordinate system, or may be an angle range in a local coordinate system of a receiving device, and further includes an azimuth range and/or a pitch angle range; and
a location detection range, which may be an angle range in a global coordinate system, or may be an angle range in a local coordinate system of a receiving device, and specifically may be, for example, an x-axis range and/or a y-axis range and/or a z-axis range in a Cartesian coordinate system.

In this embodiment of this application, the second device may indicate the detection range in the following manner: the measurement quantity+the detection range. One measurement quantity may correspond to a plurality of detection ranges.

A sensing measurement type may be indicated by using the detection range corresponding to the measurement quantity. For example, whether detection of a static target and/or a moving target is included may be determined based on the Doppler/speed detection range, and whether detection of a short-range target and/or a long-range target is included may be determined based on the delay/distance/location detection range.

The detection range corresponding to the measurement quantity may be further used to indicate a receive end to use different measurement methods based on different sensing services, that is, to filter a delay domain/Doppler domain/angle domain result based on the detection range or the filtering parameter, to reduce interference and improve detection precision. For example, for respiration detection, an indicated Doppler detection range is [0.1 Hz, 1 Hz], and a receiving device detects a respiration frequency after filtering a Doppler domain result based on this range, to avoid interference caused by movement of another target in an environment.

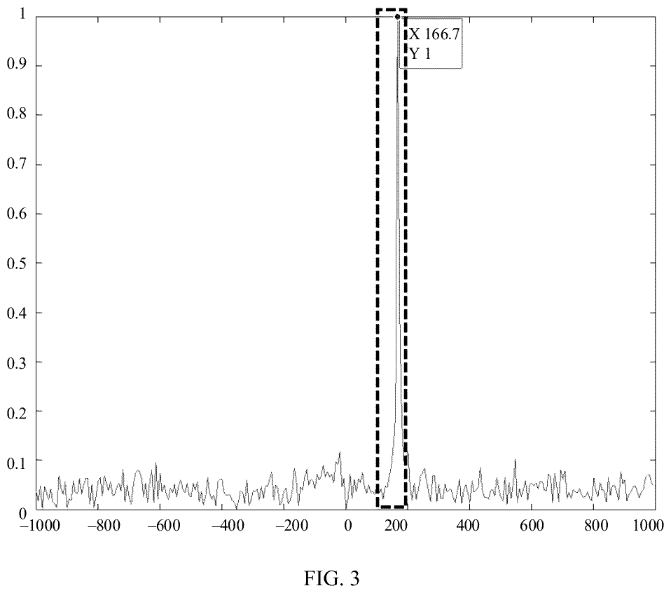

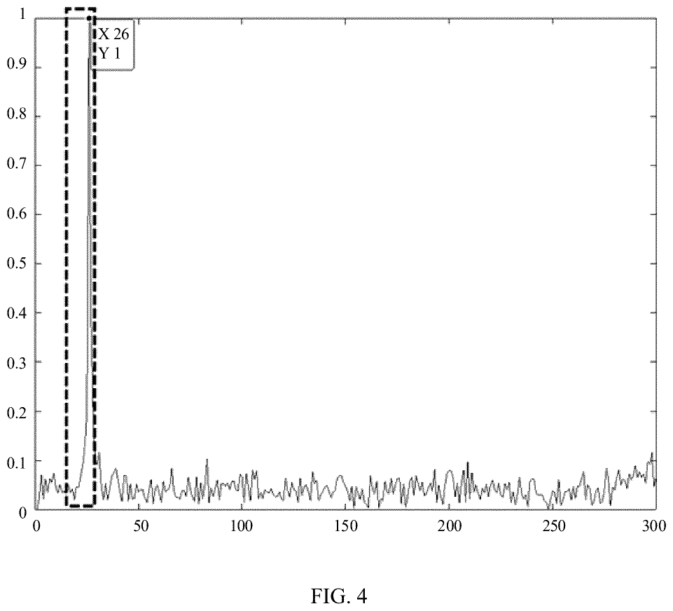

It should be noted that, the detection range indicated by the first indication information may be a value with physical significance, for example, a specific delay range or a specific Doppler range; or may be an index range, for example, a sensing measurement quantity is a Doppler, a quantity of time domain sampling points of a first signal used for sensing measurement is N, and a corresponding quantity of Doppler domain sampling points is also N; or the indicated detection range is [X1, X2], where 0≤X1≤X2≤N−1, and X1 and X2 are indexes obtained after Fourier transform. Specifically, for example, the quantity of time domain sampling points (the quantity of Doppler domain sampling points) is N=300. In an indication manner, a real detected Doppler range [100 Hz, 200 Hz] is indicated, as shown in a dashed-line box in FIG. 3. In another indication manner, a detected Fourier transform index range [20, 30] is indicated, as shown in a dashed-line box in FIG. 4.
(2) The first device receives and measures the first signal and feeds back a measurement result based on the first indication information.

The first device determines, based on the measurement quantity and the detection range indicated by the first indication information, configuration information of the first signal used for sensing, for example, determines, based on the detection range information, a time domain resource length T, a time domain resource interval ΔT, a frequency domain resource length B, and a frequency domain resource interval ΔF that are of the first signal used for sensing. In other words, the detection range is associated with the configuration information of the first signal, which is similar to that the sensing measurement type is associated with the configuration information of the first signal in the foregoing embodiment.

The first device determines a corresponding measurement method based on the detection range corresponding to the measurement quantity, for example, detects, based on the detection range, a measurement result of a measurement target in the corresponding detection range, or performs filtering based on the detection range and then obtains a corresponding measurement result.

The first device reports, based on the detection range corresponding to the indicated measurement quantity, a measurement result that meets a requirement. For example, if the indicated detection range is a Doppler detection range, a corresponding measurement result is a Doppler frequency of a detection target. For example, if the detection range indicated by the first indication information is the real detected Doppler range [100 Hz, 200 Hz], a Doppler frequency 166.7 corresponding to a peak in the detection range is reported, or a relative Doppler frequency value 166.7−100=66.7 (corresponding quantized information may be reported) in the range is reported. Alternatively, if the first indication information indicates the detected Fourier transform index range [20, 30], a fast Fourier transform (FFT) index value corresponding to a peak value in the detection range is reported, which may be specifically an absolute index value 26, or may be a relative index value 26−20=6 in the detection range (which can be represented by using fewer bits to reduce overheads).

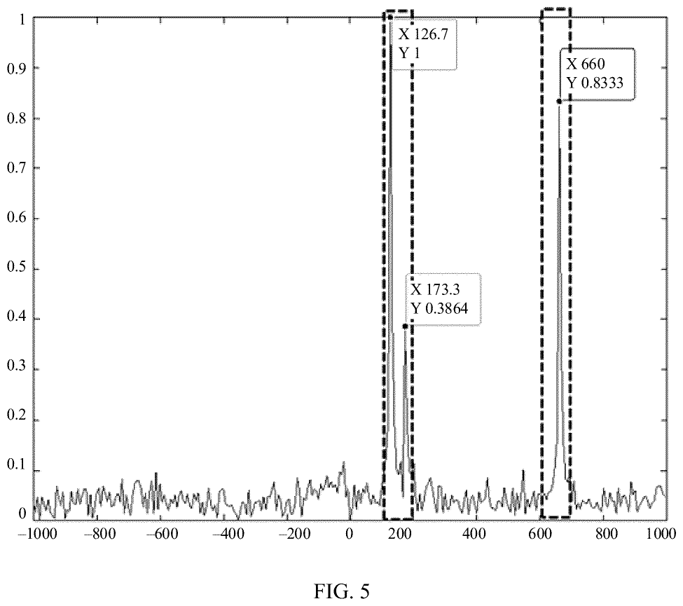

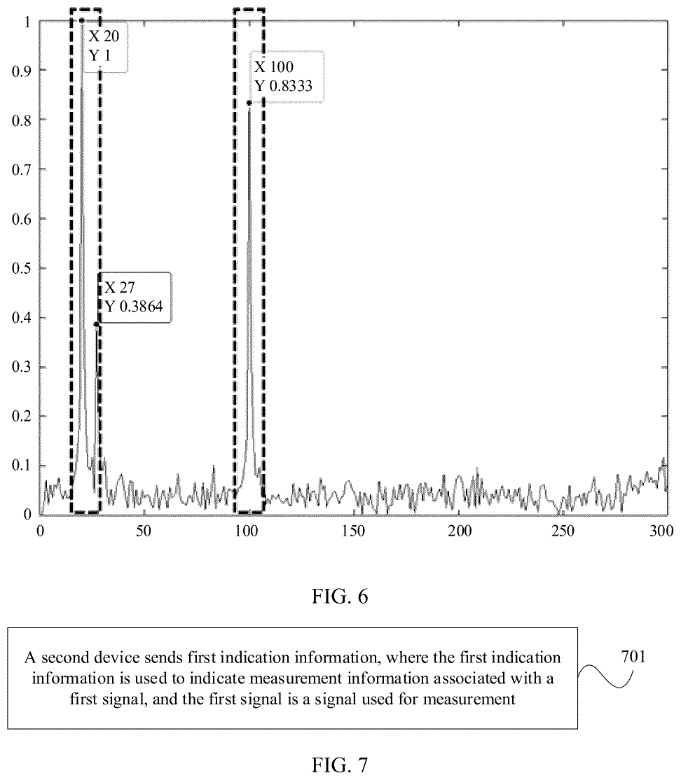

In addition, in a case of indicating a plurality of detection ranges, in addition to the measurement result, information related to the measurement result may be reported, for example, a detection range corresponding to the measurement result and a quantity of detection targets in the detection range. For example, as shown in FIG. 5, if the detection range is a Doppler detection range 1 [100 Hz, 200 Hz] or a Doppler detection range 2 [600 Hz, 700 Hz], and the measurement quantity is a Doppler frequency, reported content may be: {detection range 1, 2 (quantity of detection targets), 126.7, 173.3}, where 126.7 and 173.3 represent measurement results; and {detection range 2, 1 (quantity of detection targets), 660}, where 660 represents a measurement result. A Doppler frequency value may be a real value or a corresponding quantized result, or may be a relative Doppler frequency value (26.7, 73.3) in the range or a corresponding quantized result. Alternatively, as shown in FIG. 6, if the detection range is an FFT index range 1 [20, 30] or an FFT index range 2 [95, 105], and the measurement quantity is a Doppler frequency, reported content may be: {range 1, 2 (quantity of detection targets), 20, 27}, where 20 and 27 represent measurement results represented by an FFT index; and {range 2, 1 (quantity of detection targets), 100}, where 100 represents a measurement result represented by an FFT index, or may be a relative index value in the detection range.

In an embodiment of this application, the second device has specific sensing prior information, for example, a quantity of sensing targets, and the second device indicates, to the first device by using the first indication information, a quantity of measurement targets corresponding to target information. The target information includes at least one of the sensing measurement type, the detection range, and the measurement device information.

Specifically, the first indication information includes the sensing measurement type+the quantity of measurement targets, or includes the measurement quantity+the detection range+the quantity of measurement targets. The first device determines a measurement method and a reporting behavior based on content indicated by the first indication information, For example, whether detection of a static target and/or a moving target is included may be determined based on the Doppler/speed detection range, a quantity of measurement results corresponding to the Doppler/speed detection range that need to be reported is determined based on a quantity of measurement targets corresponding to the Doppler/speed detection range, whether detection of a short-range target and/or a long-range target is included is determined based on the delay/distance/location detection range, and a quantity of measurement targets the delay/distance/location detection range that need to be reported is determined based a quantity of measurement targets corresponding to the delay/distance/location detection range.

Specifically, a corresponding behavior of the first device is reporting measurement results of N measurement targets that meet a requirement of the sensing measurement type or a requirement of the detection range. For example, the sensing measurement type is detection of a high-speed moving target, and a corresponding measurement result is a Doppler frequency of a measurement target. In this case, after performing static clutter cancellation on a received signal, a receiving device performs peak detection or threshold detection in a Doppler frequency range (≥f1 Hz) corresponding to the high-speed moving target, and reports Doppler frequency values corresponding to N signal paths with strongest power. Similar to the foregoing embodiment, a real Doppler frequency value or a relative Doppler frequency value may be reported (corresponding quantized information may be reported), or an FFT index value may be reported. For another example, as shown in FIG. 5, the detection range indicated by the first indication information sent by the second device is a Doppler detection range 1 [100 Hz, 200 Hz], where a quantity of measurement targets is 2, or a Doppler range 2 [600 Hz, 700 Hz], where a quantity of measurement targets is 1, and the measurement quantity is a Doppler frequency. In this case, reported content may be: {126.7, 173.3} (corresponding to the detection range 1); and {660} (corresponding to the detection range 2). A Doppler frequency value may be a real value or a corresponding quantized result, or may be a relative Doppler frequency value (26.7, 73.3) in the range or a corresponding quantized result. Alternatively, the detection range is an FFT index range, as shown in FIG. 6, and details are not described herein.

In addition, if a quantity N′ of measurement targets that meet the requirement of the sensing measurement type or the requirement of the detection range and that are detected by the first device is inconsistent with a quantity N of measurement targets indicated by the first indication information, for example, N′<N, the first device reports the quantity N′ (and/or measurement results) of detected measurement targets to the second device. Specially, if a measurement target that meets the requirement of the sensing measurement type or the requirement of the detection range is not detected, that is, N′=0, the first device feeds back that no measurement target is detected.

In this embodiment of this application, the first device obtains the first indication information, and measures the first signal based on the first indication information to obtain the measurement result and/or report the measurement result. The first indication information is used to indicate the measurement information associated with the first signal. Therefore, corresponding measurement information may be set based on a sensing requirement, so that the measurement result obtained based on the first indication information can meet the sensing requirement, thereby effectively improving sensing performance.

As shown in FIG. 7, an embodiment of this application further provides an information transmission method, including the following steps:

Step 701: A second device sends first indication information, where the first indication information is used to indicate measurement information associated with a first signal, and the first signal is a signal used for measurement.

In this embodiment of this application, the second device sends the first indication information, so that a first device measures the first signal based on the first indication information to obtain a measurement result and/or report the measurement result. The first indication information is used to indicate the measurement information associated with the first signal, such as a sensing measurement type, a measurement quantity, a detection range corresponding to the measurement quantity, and/or measurement device information. Therefore, corresponding measurement information may be set based on a sensing requirement, so that the measurement result obtained based on the first indication information can meet the sensing requirement, thereby effectively improving sensing performance.

Optionally, the measurement information includes at least one of the following:
a sensing measurement type;
a measurement quantity;
a detection range corresponding to the measurement quantity; and
measurement device information.

Optionally, the detection range includes at least one of the following:
a Doppler or speed detection range;
a delay or distance detection range;
an angle detection range; and
a location detection range.

Optionally, the first indication information is further used to indicate a quantity of measurement targets corresponding to target information.

The target information includes at least one of the sensing measurement type, the detection range, and the measurement device information.

Optionally, the sensing measurement type includes at least one of the following:
a motion type;
a static type;
a short-range type; and
a long-range type.

Optionally, the motion type includes at least one of the following:
a high-speed motion type; and
a low-speed motion type.

Optionally, the first indication information is further used to indicate configuration information of the first signal.

Optionally, the configuration information of the first signal includes at least one of the following:
a signal resource identifier, where the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

In this embodiment of this application, the second device sends the first indication information, so that the first device measures the first signal based on the first indication information to obtain the measurement result and/or report the measurement result. The first indication information is used to indicate the measurement information associated with the first signal, such as the sensing measurement type, the measurement quantity, the detection range corresponding to the measurement quantity, and/or the measurement device information. Therefore, corresponding measurement information may be set based on a sensing requirement, so that the measurement result obtained based on the first indication information can meet the sensing requirement, thereby effectively improving sensing performance.

The information processing method provided in the embodiments of this application may be performed by an information processing apparatus. In the embodiments of this application, an example in which the information processing apparatus performs the information processing method is used to describe the information processing apparatus provided in the embodiments of this application.

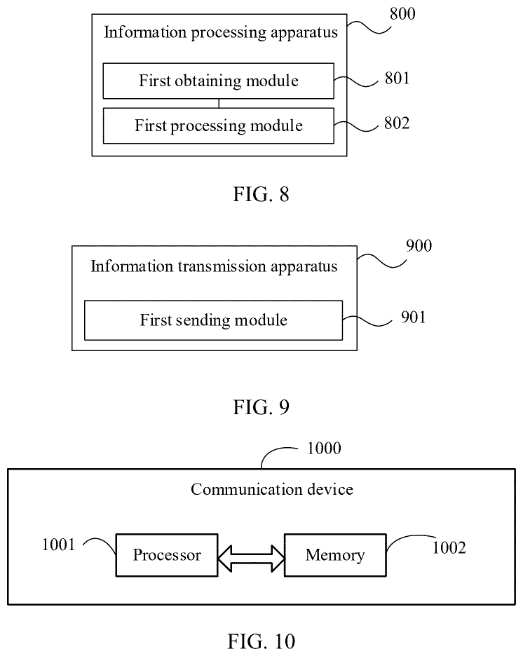

As shown in FIG. 8, an embodiment of this application further provides an information processing apparatus 800, applied to a first device. The apparatus includes:
a first obtaining module 801, configured to obtain first indication information, where the first indication information is used to indicate measurement information associated with a first signal, and the first signal is a signal used for measurement; and
a first processing module 802, configured to perform a first operation based on the first indication information.

The first operation includes at least one of the following:
measuring the first signal to obtain at least one measurement result; and
reporting first information, where the first information includes at least one measurement result.

Optionally, the measurement information includes at least one of the following:
a sensing measurement type;
a measurement quantity;
a detection range corresponding to the measurement quantity; and
measurement device information.

Optionally, the apparatus in this embodiment of this application further includes:
a first determining module, configured to determine, based on the sensing measurement type, at least one of a processing manner of a measurement result, the detection range corresponding to the measurement quantity, and a measurement device.

Optionally, the first processing module is further configured to perform at least one of the following:
reporting a measurement result of a measurement target corresponding to the sensing measurement type;
reporting a measurement result of a measurement target in the detection range; and
reporting a measurement result measured by a measurement device corresponding to the measurement device information.

Optionally, the detection range includes at least one of the following:
a Doppler or speed detection range;
a delay or distance detection range;
an angle detection range; and
a location detection range.

Optionally, the first indication information is further used to indicate a quantity of measurement targets corresponding to target information.

The target information includes at least one of the sensing measurement type, the detection range, and the measurement device information.

Optionally, the first information further includes at least one of the following:
target information corresponding to the measurement result; and
a quantity of measurement targets corresponding to the target information.

Optionally, the sensing measurement type includes at least one of the following:
a motion type;
a static type;
a short-range type; and
a long-range type.

Optionally, the motion type includes at least one of the following:
a high-speed motion type; and
a low-speed motion type.

Optionally, the first indication information is further used to indicate configuration information of the first signal.

Optionally, the apparatus in this embodiment of this application further includes:
a first receiving module, configured to receive the first signal based on the configuration information of the first signal.

Optionally, the configuration information of the first signal includes at least one of the following:
a signal resource identifier, where the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

In this embodiment of this application, the first device obtains the first indication information, and measures the first signal based on the first indication information to obtain the measurement result and/or report the measurement result. The first indication information is used to indicate the measurement information associated with the first signal, such as the sensing measurement type, the measurement quantity, the detection range corresponding to the measurement quantity, and/or the measurement device information. Therefore, corresponding measurement information may be set based on a sensing requirement, so that the measurement result obtained based on the first indication information can meet the sensing requirement, thereby effectively improving sensing performance.

As shown in FIG. 9, an embodiment of this application further provides an information transmission apparatus 900, applied to a second device. The apparatus includes:
a first sending module 901, configured to send first indication information, where the first indication information is used to indicate measurement information associated with a first signal, and the first signal is a signal used for measurement.

Optionally, the measurement information includes at least one of the following:
a sensing measurement type;
a measurement quantity;
a detection range corresponding to the measurement quantity; and
measurement device information.

Optionally, the detection range includes at least one of the following:
a Doppler or speed detection range;
a delay or distance detection range;
an angle detection range; and
a location detection range.

Optionally, the first indication information is further used to indicate a quantity of measurement targets corresponding to target information.

The target information includes at least one of the sensing measurement type, the detection range, and the measurement device information.

Optionally, the sensing measurement type includes at least one of the following:
a motion type;
a static type;
a short-range type; and
a long-range type.

Optionally, the motion type includes at least one of the following:
a high-speed motion type; and
a low-speed motion type.

Optionally, the first indication information is further used to indicate configuration information of the first signal.

Optionally, the configuration information of the first signal includes at least one of the following:
a signal resource identifier, where the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

In this embodiment of this application, the second device sends the first indication information, so that the first device measures the first signal based on the first indication information to obtain the measurement result and/or report the measurement result. The first indication information is used to indicate the measurement information associated with the first signal, such as the sensing measurement type, the measurement quantity, the detection range corresponding to the measurement quantity, and/or the measurement device information. Therefore, corresponding measurement information may be set based on a sensing requirement, so that the measurement result obtained based on the first indication information can meet the sensing requirement, thereby effectively improving sensing performance.

The information processing apparatus in this embodiment of this application may be an electronic device, for example, an electronic device with an operating system, or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The information processing apparatus provided in this embodiment of this application can implement the processes implemented in the method embodiments of FIG. 2 to FIG. 7, and achieve same technical effects. To avoid repetition, details are not described herein again.

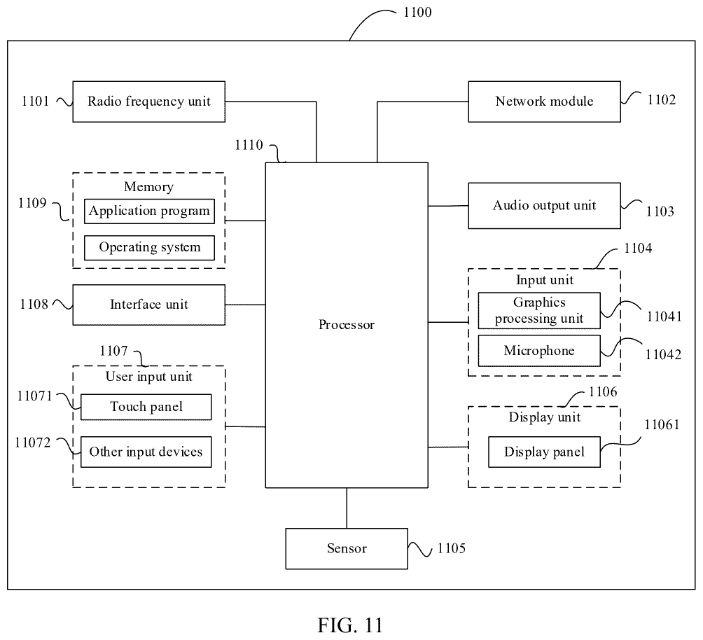

Optionally, as shown in FIG. 10, an embodiment of this application further provides a communication device 1000, including a processor 1001 and a memory 1002, and the memory 1002 stores a program or instructions capable of running on the processor 1001. For example, when the communication device 1000 is a terminal, the program or the instructions are executed by the processor 1001 to implement the steps in the foregoing embodiment of the information processing method, and same technical effects can be achieved. When the communication device 1000 is a network-side device, the program or the instructions are executed by the processor 1001 to implement the steps in the foregoing embodiment of the information processing method or the information transmission method, and same technical effects can be achieved. To avoid repetition, details are not described herein again.

An embodiment of this application further provides a terminal, including a processor and a communication interface. The communication interface is configured to obtain first indication information, where the first indication information is used to indicate measurement information associated with a first signal, and the first signal is a signal used for measurement. The processor is configured to perform a first operation based on the first indication information. The first operation includes at least one of the following: measuring the first signal to obtain at least one measurement result; and reporting first information, where the first information includes at least one measurement result. The measurement information includes at least one of the following: a sensing measurement type; a measurement quantity; a detection range corresponding to the measurement quantity; and measurement device information. The terminal embodiment corresponds to the foregoing method embodiment on the first device side. Each implementation process and implementation of the foregoing method embodiment may be applied to the terminal embodiment, and same technical effects can be achieved. Specifically, FIG. 11 is a schematic diagram of a hardware structure of a terminal for implementing an embodiment of this application.

The terminal 1100 includes but is not limited to at least some components in a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that the terminal 1100 may further include a power supply (for example, a battery) that supplies power to each component. The power supply may be logically connected to the processor 1110 by using a power management system, to implement functions such as charging management, discharging management, and power consumption management through the power management system. The structure of the terminal shown in FIG. 11 does not constitute a limitation on the terminal. The terminal may include more or fewer components than those shown in the figure, or combine some components, or have different component arrangements. Details are not described herein again.

It should be understood that in this embodiment of this application, the input unit 1104 may include a graphics processing unit (GPU) 11041 and a microphone 11042, and the graphics processing unit 11041 processes image data of a still picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1101 may transmit the downlink data to the processor 1110 for processing. In addition, the radio frequency unit 1101 may send uplink data to a network-side device. Generally, the radio frequency unit 1101 includes but is not limited to an antenna, an amplifier, a transceiver, a coupler, a low-noise amplifier, a duplexer, and the like.

The memory 1109 may be configured to store a software program or instructions and various types of data. The memory 1109 may mainly include a first storage area for storing a program or instructions and a second storage area for storing data. The first storage area may store an operating system, an application program or instructions required by at least one function (for example, a sound play function or an image play function), and the like. In addition, the memory 1109 may include a volatile memory or a non-volatile memory, or the memory 1109 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1109 in this embodiment of this application includes but is not limited to these memories and any other suitable type of memory.

The processor 1110 may include one or more processing units. Optionally, the processor 1110 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1110.

The radio frequency unit 1101 is configured to obtain first indication information, where the first indication information is used to indicate measurement information associated with a first signal, and the first signal is a signal used for measurement.

The processor 1110 is configured to perform a first operation based on the first indication information.

The first operation includes at least one of the following:
measuring the first signal to obtain at least one measurement result; and
reporting first information, where the first information includes at least one measurement result.

Optionally, the measurement information includes at least one of the following:
a sensing measurement type;
a measurement quantity;
a detection range corresponding to the measurement quantity; and
measurement device information.

Optionally, the processor 1110 is further configured to determine, based on the sensing measurement type, at least one of a processing manner of a measurement result, the detection range corresponding to the measurement quantity, and a measurement device.

Optionally, the processor 1110 is further configured to perform at least one of the following by using the radio frequency unit 1101:
reporting a measurement result of a measurement target corresponding to the sensing measurement type;
reporting a measurement result of a measurement target in the detection range; and
reporting a measurement result measured by a measurement device corresponding to the measurement device information.

Optionally, the detection range includes at least one of the following:
a Doppler or speed detection range;
a delay or distance detection range;
an angle detection range; and
a location detection range.

Optionally, the first indication information is further used to indicate a quantity of measurement targets corresponding to target information.

The target information includes at least one of the sensing measurement type, the detection range, and the measurement device information.

Optionally, the first information further includes at least one of the following:
target information corresponding to the measurement result; and
a quantity of measurement targets corresponding to the target information.

Optionally, the sensing measurement type includes at least one of the following:
a motion type;
a static type;
a short-range type; and
a long-range type.

Optionally, the motion type includes at least one of the following:
a high-speed motion type; and
a low-speed motion type.

Optionally, the first indication information is further used to indicate configuration information of the first signal.

Optionally, the radio frequency unit 1101 is further configured to:
receive the first signal based on the configuration information of the first signal.

Optionally, the configuration information of the first signal includes at least one of the following:
a signal resource identifier, where the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

In this embodiment of this application, the first device obtains the first indication information, and measures the first signal based on the first indication information to obtain the measurement result and/or report the measurement result. The first indication information is used to indicate the measurement information associated with the first signal, such as the sensing measurement type, the measurement quantity, the detection range corresponding to the measurement quantity, and/or the measurement device information. Therefore, corresponding measurement information may be set based on a sensing requirement, so that the measurement result obtained based on the first indication information can meet the sensing requirement, thereby effectively improving sensing performance.

An embodiment of this application further provides a network-side device, including a processor and a communication interface. The communication interface is configured to obtain first indication information, where the first indication information is used to indicate measurement information associated with a first signal, and the first signal is a signal used for measurement. The processor is configured to perform a first operation based on the first indication information. The first operation includes at least one of the following: measuring the first signal to obtain at least one measurement result; and reporting first information, where the first information includes at least one measurement result. Alternatively, the communication interface is configured to send first indication information, where the first indication information is used to indicate measurement information associated with a first signal, and the first signal is a signal used for measurement. The network-side device embodiment corresponds to the foregoing method embodiment on the first device side or the second device side. Each implementation process and implementation of the foregoing method embodiment may be applied to the network-side device embodiment, and same technical effects can be achieved.

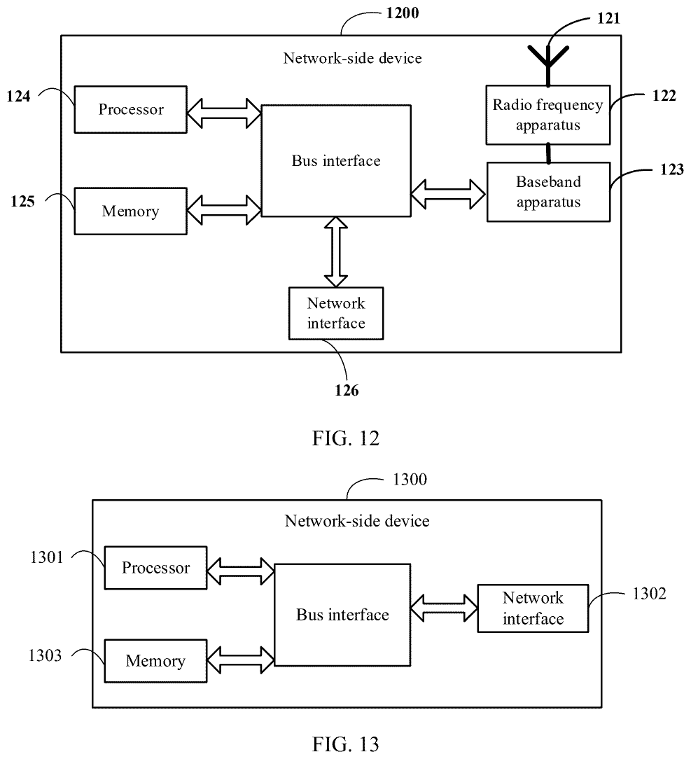

Specifically, an embodiment of this application further provides a network-side device. As shown in FIG. 12, the network-side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information, and sends processed information to the radio frequency apparatus 122. After processing the received information, the radio frequency apparatus 122 sends processed information through the antenna 121.

The method performed by the first device or the second device in the foregoing embodiment may be implemented in the baseband apparatus 123, and the baseband apparatus 123 includes a baseband processor.

For example, the baseband apparatus 123 may include at least one baseband board. A plurality of chips are disposed on the baseband board. As shown in FIG. 12, one of the chips is, for example, a baseband processor, and is connected to the memory 125 by using a bus interface, to invoke a program in the memory 125 to perform the operation of the first device or the second device shown in the foregoing method embodiment.

The network-side device may further include a network interface 126. For example, the interface is a common public radio interface (CPRI).

Specifically, the network-side device 1200 in this embodiment of this application further includes instructions or a program stored in the memory 125 and capable of running on the processor 124. The processor 124 invokes the instructions or the program in the memory 125 to perform the method performed by the modules shown in FIG. 8 or FIG. 9, and same technical effects are achieved. To avoid repetition, details are not described herein again.

Specifically, an embodiment of this application further provides a network-side device. As shown in FIG. 13, the network-side device 1300 includes a processor 1301, a network interface 1302, and a memory 1303. The network interface 1302 is, for example, a common public radio interface (CPRI).

Specifically, the network-side device 1300 in this embodiment of this application further includes instructions or a program stored in the memory 1303 and capable of running on the processor 1301. The processor 1301 invokes the instructions or the program in the memory 1303 to perform the method performed by the modules shown in FIG. 9, and same technical effects are achieved. To avoid repetition, details are not described herein again.

An embodiment of this application further provides a readable storage medium. The readable storage medium stores a program or instructions. The program or the instructions are executed by a processor to implement the processes in the foregoing embodiment of the information processing method or the information transmission method, and same technical effects can be achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiment of the information processing method or the information transmission method, and same technical effects can be achieved. To avoid repetition, details are not described herein again.

It should be understood that, the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing embodiment of the information processing method or the information transmission method, and same technical effects can be achieved. To avoid repetition, details are not described herein again.

An embodiment of this application further provides an information processing system, including a terminal and a network-side device. The terminal may be configured to perform the steps of the information processing method described above, and the network-side device may be configured to perform the steps of the information transmission method described above.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in an order shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. An information processing method, comprising:
obtaining, by a first device, first indication information, wherein the first indication information is used to indicate measurement information associated with a first signal, and the first signal is a signal used for measurement; and
performing, by the first device, a first operation based on the first indication information, wherein
the first operation comprises at least one of the following:
measuring the first signal to obtain at least one measurement result; and
reporting first information, wherein the first information comprises at least one measurement result, wherein
the measurement information comprises at least one of the following:
a sensing measurement type;
a measurement quantity;
a detection range corresponding to the measurement quantity; and
measurement device information.

2. The method according to claim 1, wherein the first indication information comprises the sensing measurement type, and the method further comprises:
determining, by the first device based on the sensing measurement type, at least one of a processing manner of a measurement result, the detection range corresponding to the measurement quantity, and a measurement device.

3. The method according to claim 1, wherein the reporting first information comprises at least one of the following:
reporting a measurement result of a measurement target corresponding to the sensing measurement type;
reporting a measurement result of a measurement target in the detection range; and
reporting a measurement result measured by a measurement device corresponding to the measurement device information.

4. The method according to claim 1, wherein the detection range comprises at least one of the following:
a Doppler or speed detection range;
a delay or distance detection range;
an angle detection range; and
a location detection range.

5. The method according to claim 1, wherein the first indication information is further used to indicate a quantity of measurement targets corresponding to target information; and
the target information comprises at least one of the sensing measurement type, the detection range, and the measurement device information.

6. The method according to claim 5, wherein the first information further comprises at least one of the following:
target information corresponding to the measurement result; and
a quantity of measurement targets corresponding to the target information.

7. The method according to claim 2, wherein the sensing measurement type comprises at least one of the following:
a motion type;
a static type;
a short-range type; and
a long-range type;
wherein the motion type comprises at least one of the following:
a high-speed motion type; and
a low-speed motion type.

8. The method according to claim 1, wherein the first indication information is further used to indicate configuration information of the first signal.

9. The method according to claim 8, further comprising:
receiving the first signal based on the configuration information of the first signal.

10. The method according to claim 8, wherein the configuration information of the first signal comprises at least one of the following:
a signal resource identifier, wherein the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

11. An information transmission method, comprising:
sending, by a second device, first indication information, wherein the first indication information is used to indicate measurement information associated with a first signal, and the first signal is a signal used for measurement, wherein
the measurement information comprises at least one of the following:
a sensing measurement type;
a measurement quantity;
a detection range corresponding to the measurement quantity; and
measurement device information.

12. The method according to claim 11, wherein the detection range comprises at least one of the following:
a Doppler or speed detection range;
a delay or distance detection range;
an angle detection range; and
a location detection range.

13. The method according to claim 11, wherein the first indication information is further used to indicate a quantity of measurement targets corresponding to target information; and
the target information comprises at least one of the sensing measurement type, the detection range, and the measurement device information.

14. The method according to claim 11, wherein the sensing measurement type comprises at least one of the following:
a motion type;
a static type;
a short-range type; and
a long-range type;
wherein the motion type comprises at least one of the following:
a high-speed motion type; and
a low-speed motion type.

15. The method according to claim 11, wherein the first indication information is further used to indicate configuration information of the first signal.

16. The method according to claim 15, wherein the configuration information of the first signal comprises at least one of the following:
a signal resource identifier, wherein the signal resource identifier is used to distinguish configuration information of different first signals;
a waveform;
a subcarrier spacing;
a guard interval;
a frequency domain start location;
a time domain start location;
a time domain resource length;
a time domain resource interval;
a frequency domain resource length;
a frequency domain resource interval;
signal power;
sequence information;
a signal direction; and
a quasi co-location QCL relationship.

17. A first device, comprising a processor and a memory, wherein the memory stores a program or instructions capable of running on the processor, and the program or the instructions are executed by the processor to implement:
obtaining first indication information, wherein the first indication information is used to indicate measurement information associated with a first signal, and the first signal is a signal used for measurement; and
performing a first operation based on the first indication information, wherein
the first operation comprises at least one of the following:
measuring the first signal to obtain at least one measurement result; and
reporting first information, wherein the first information comprises at least one measurement result, wherein
the measurement information comprises at least one of the following:
a sensing measurement type;
a measurement quantity;
a detection range corresponding to the measurement quantity; and
measurement device information.

18. A second device, comprising a processor and a memory, wherein the memory stores a program or instructions capable of running on the processor, and the program or the instructions are executed by the processor to implement the steps of the information transmission method according to claim 11.

19. A non-transitory readable storage medium, wherein the non-transitory readable storage medium stores a program or instructions, and the program or the instructions are executed by a processor to implement the steps of the information processing method according to claim 1.

20. A non-transitory readable storage medium, wherein the non-transitory readable storage medium stores a program or instructions, and the program or the instructions are executed by a processor to implement the steps of the information processing method according to claim 11.
